(19) United States
(12) Patent Application Publication
(10) Pub. No.: US 2006/0100940 A1
(43) Pub. Date: May 11, 2006

(54) Analyzing product portfolios

(76) Inventors: Steve Kakouros, Grenoble (FR); Brian D. Cargille, Palo Alto, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/978,986

(22) Filed: Nov. 1, 2004

(51) Int. Cl. G06F 9/44; G06F 17/50

(52) U.S. Cl. 705/28; 705/7

(57) ABSTRACT

Methods, systems, and computer programs for analyzing product portfolios are described. In one aspect, demand data, lead time data, and inventory data are received for a product portfolio comprising a set of finished products manufactured from a set of associated parts. A measure of inventory cost is computed for the product portfolio as a whole. A measure of order responsiveness is computed for the product offering as a whole. A report evaluating the product portfolio based on the computed measures of inventory cost and order responsiveness is presented.

### BACKGROUND

Asset managers of large manufacturing enterprises, for example, computer manufacturers, electronics manufacturers and auto manufacturers, must determine the inventory levels of components and finished products that are needed to meet target end customer service levels (i.e., the fraction of customer orders that should be received by the requested delivery dates). For such manufacturing enterprises, the delivery of a finished product to an end customer typically involves a complex network of suppliers, fabrication sites, assembly locations, distribution centers and customer locations through which components and products flow. This network may be modeled as a supply chain that includes all significant entities participating in the transformation of raw materials or basic components into the finished products that ultimately are delivered to the end customer.

Manufacturers face many pressures, such as competitive markets, leapfrogging technology, price erosion, and demand uncertainty. With less differentiation between product functionality among vendors, the ability to attract customers is often seen as being increasingly tied to service levels and product options. As a result, manufacturers often are driven to increase the number of product offerings, or “fan-out”, and to have all products highly available at the point of sale.

However, increasing product fan-out comes with the downside of increasing production planning costs and inventory costs. For example, demand variability requires higher stocking levels in order to ensure product availability and, therefore, total inventory targets must be multiplied by the number of product offerings to ensure that all products are in stock as needed. A penalty also comes at the product end-of-life, when unsold units lose value and must be written off or sold at a steep discount.

Manufacturing enterprises must arrange for the delivery of component parts and other resources that are needed to produce the finished products that are delivered to end customers. Production planners set inventory levels, capacity levels, and manufacturing build plans for finished products based on various forecasts that are generated for each product offering. For production planners, more product offerings means more products to forecast, more inventory to stock, and a greater risk of stock-outs.

Production planning organizations, such as sales, marketing, and finance, often have the most knowledge of the risks and uncertainties associated with the supply chain. Thus, such organizations are best positioned to manage procurement risks and uncertainties. Production planners, however, often do not have much input into the decisions regarding the number of products to offer. In addition, hitherto, production planners have not had the metrics needed to evaluate and compare different product portfolios and, therefore, could not effectively communicate the tradeoffs between different product portfolios that might justify reducing the number of product offerings in a current product portfolio.

### SUMMARY

In one aspect, the invention features a machine-implemented method of analyzing product portfolios. In accordance with this inventive method demand data, lead time data, and inventory data are received for a product portfolio comprising a set of finished products manufactured from a set of associated parts. A measure of inventory cost is computed for the product portfolio as a whole. A measure of order responsiveness is computed for the product offering as a whole. A report evaluating the product portfolio based on the computed measures of inventory cost and order responsiveness is presented.

The invention also features a product portfolio analysis machine and a product portfolio analysis computer program for implementing the above-described procurement risk management method.

Other features and advantages of the invention will become apparent from the following description, including the drawings and the claims.

### DESCRIPTION OF DRAWINGS

FIG. 1 is a block diagram of an exemplary supply chain that includes a firm that sells to one or more customers finished products manufactured from parts received from one or more suppliers and a spot market.

FIG. 2 is a diagrammatic view of an embodiment of a product portfolio analysis system 10 that includes a product portfolio analyzer and a database.

FIG. 3 is a flow diagram of an embodiment of a method of operating the product portfolio analyzer embodiment of FIG. 2.

FIG. 4 is a block diagram of data flow in an implementation of the method of FIG. 3.

FIG. 5 is a flow diagram of an embodiment of a method of generating and evaluating a baseline product portfolio.

FIG. 6 is a diagrammatic view of the fields in an implementation of an inventory table.

FIG. 7 is a diagrammatic view of the fields in an implementation of an orders table.

FIG. 8 is a diagrammatic view of the fields in an implementation of a stock keeping number (SKU) table.

FIG. 9 shows an exemplary order aging curve.

FIG. 10 is a diagrammatic view of an implementation of a baseline evaluation report.

FIG. 11 is a diagrammatic view of an implementation of a performance report.

FIG. 12 is a diagrammatic view of an implementation of an overstocked feature performance report.

FIG. 13 is a flow diagram of an embodiment of a method of analyzing a product portfolio scenario.

FIG. 14 shows an embodiment of a graphical user interface for receiving user input defining a product portfolio scenario based on a modification of a baseline product portfolio.

FIG. 15 shows the graphical user interface shown in FIG. 14 displaying a list of SKUs in the baseline product portfolio of a selected type and a list of potential replacement SKUs.

FIG. 16 shows the graphical user interface shown in FIG. 15 after a user has designated the substitution of one of the potential replacement SKUs for one of the SKUs in the baseline product portfolio.

FIG. 17 shows the graphical user interface shown in FIG. 16 after the user has designated several substitutions of potential replacement SKUs for corresponding ones of the SKUs in the baseline product portfolio.

FIG. 18 shows the graphical user interface shown in FIG. 17 displaying metrics comparing the baseline portfolio and the designated product portfolio scenario.

### DETAILED DESCRIPTION

In the following description, like reference numbers are used to identify like elements. Furthermore, the drawings are intended to illustrate major features of exemplary embodiments in a diagrammatic manner. The drawings are not intended to depict every feature of actual embodiments nor relative dimensions of the depicted elements, and are not drawn to scale.

I. Operating Environment

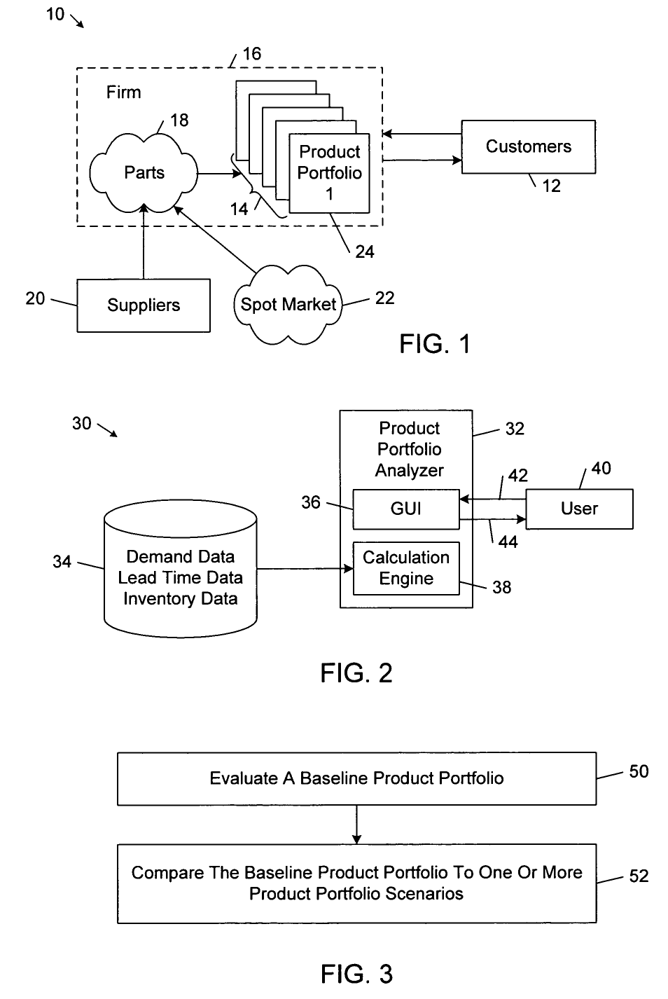

Referring to FIG. 1, in one illustrative embodiment, a simplified distribution system (or supply chain) 10 includes a set of customers 12 expressing cumulative demand levels for a particular set of finished products 14 that drive the production of those finished products 14. The finished products 14 are produced by a firm 16 that sells the finished products 14 to customers 12 directly. In other implementations, the firm 16 also may sell products 14 to customers 12 indirectly through a supply channel that includes distributors (or resellers), retailers, and valued-added resellers. The firm 16 may include a manufacturing line that is configured to assemble the finished products 14 from component parts 18 (or raw materials) that may be supplied directly from one or more component part suppliers 20 or indirectly through a spot market 22.

In operation, end customer demand drives orders, which are satisfied by shipments of the finished products 14 from inventories. Production planners for firm 16 schedule the delivery of the finished products 14 so that the inventory levels are sufficient to cover both expected end customer demand and uncertainty in end customer demand. In general, various demand forecasting techniques may be used to project future demand by end customers 12 for the finished products 14.

The finished products 14 typically are grouped into product portfolios 24, each of which contains a respective group of closely-related finished products 14 that have similar features and, oftentimes, are manufactured from many of the same component parts 18. The product portfolio analysis embodiments described in detail below enable production planners to evaluate and compare different product portfolios. In this way, these embodiments allow product planners to effectively communicate the tradeoffs between different product portfolios that might justify reducing the number of product offerings in a current product portfolio and, thereby, reduce production costs and complexity.

II. System Overview

FIG. 2 shows an embodiment of a product portfolio analysis system 30 that includes a product portfolio analyzer 32 and a database 34. The database 34 stores demand data, lead time data, and inventory data for the finished products 14 in the product portfolios 24 and the associated component parts 18. The product portfolio analyzer 32 includes a graphical user interface 36 and a calculation engine 38.

The graphical user interface 36 provides a convenient and efficient way for a user 40 in an organization, such as sales, marketing, finance or procurement, to enter data into the product portfolio analyzer 32, to visualize a product portfolio against multiple metrics, to generate product portfolio scenarios, and to run scenarios comparing different product portfolios. The graphical user interface 36 facilitates the user's interaction with the product portfolio analyzer 32 by providing an efficient interface through which a user may enter inputs 42 specifying a baseline product portfolio and product portfolio scenarios, and providing a clean and uncluttered interface for displaying reports/metrics 44 for evaluating a product portfolio reduction strategy along multiple output metric dimensions.

The calculation engine 38 operates on the data received from the user 40 and other data contained within data structures that are stored in various database tables that are accessible by the product portfolio analyzer 32. As explained in detail below, calculation engine 38 is operable to compute one or more metrics for evaluating a product portfolio and for comparing different product portfolios. The graphical user interface 36 presents these metrics in one or more product portfolio evaluation reports that enable the tradeoffs between different product portfolio strategies to be visualized and managed.

The product portfolio analyzer 32 may be implemented as one or more respective software modules operating on a computer. In one embodiment, the product portfolio analyzer 32 may be implemented as a Microsoft® Access® Database utilizing Visual Basic® for Applications (VBA) computer program operable as a spreadsheet tool in the Microsoft® Excel® application program, which is operable on a personal computer or a workstation. In general, the computer (or workstation) includes a processing unit, a system memory, and a system bus that couples the processing unit to the various components of the computer. The processing unit may include one or more processors, each of which may be in the form of any one of various commercially available processors. The system memory typically includes a read only memory (ROM) that stores a basic input/output system (BIOS) that contains start-up routines for the computer, and a random access memory (RAM). The system bus may be a memory bus, a peripheral bus or a local bus, and may be compatible with any of a variety of bus protocols, including PCI, VESA, Microchannel, ISA, and EISA. The computer also may include a hard drive, a floppy drive, and CD ROM drive that are connected to the system bus by respective interfaces. The hard drive, floppy drive, and CD ROM drive contain respective computer-readable media disks that provide non-volatile or persistent storage for data, data structures and computer-executable instructions. Other computer-readable storage devices (e.g., magnetic tape drives, flash memory devices, and digital video disks) also may be used with the computer. A user may interact (e.g., enter commands or data) with the computer using a keyboard and a mouse. Other input devices (e.g., a microphone, joystick, or touch pad) also may be provided. Information may be displayed to the user on a monitor. The computer also may include peripheral output devices, such as speakers and a printer. In addition, one or more remote computers may be connected to the computer over a local area network (LAN) or a wide area network (WAN) (e.g., the Internet).

III. Analyzing Product Portfolios

A. Overview

FIG. 3 shows an embodiment of a method by which the user 40 uses the product portfolio analyzer 32 to analyze product portfolios. In accordance with this method, the user 40 initially evaluates a baseline product portfolio (block 50). Based on this evaluation, the user 40 compares the baseline product portfolio to one or more product portfolio scenarios (block 52).

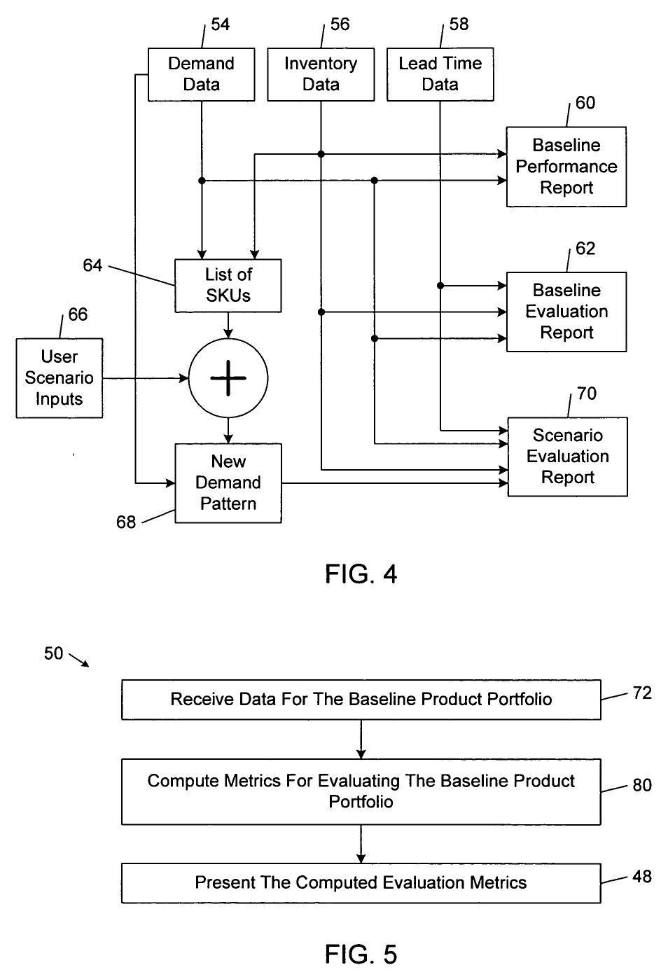

FIG. 4 shows the flow of data into and out of the product portfolio analyzer 32 during the execution of the product portfolio analysis method of FIG. 3. In the course of evaluating the baseline product portfolio and the product portfolio scenarios, the product portfolio analyzer 32 utilizes the demand data 54, the inventory data 56, and the lead time data 58 that is stored in the database 34 to generate a baseline performance report 60 and a baseline evaluation report 62. The product portfolio analyzer 32 uses the demand data 54 and the inventory data 56 to generate a list 62 of SKUs identifying the finished products and associated parts in the baseline product portfolio. The user 40 may enter scenario inputs 66 that specify a product portfolio scenario that corresponds to a modification of the list 64 of SKUs. The product portfolio analyzer 32 uses the specified product portfolio scenario and the demand data 54 to generate a new demand pattern 68 for the specified product portfolio scenario. The product portfolio analyzer 32 generates a scenario evaluation report 70 based on the new demand pattern 68.

B. Evaluating a Baseline Product Portfolio

FIG. 5 shows an implementation of the process of evaluating a baseline product portfolio (block 50; FIG. 3).

1. Receiving Data For The Baseline Product Portfolio

In accordance with the baseline product portfolio evaluation process, the product portfolio analyzer 32 receives data for the baseline product portfolio (block 72). To this end, the user 40 typically uploads data from the database 34 into the product portfolio analyzer 32. This data includes demand data 54, inventory data 56, and lead time data 58 for finished products 14 and the associated parts 18 in the selected baseline product portfolio. In some implementations, the uploaded data is stored in the following input table data structures. As used herein the terms “items” and “SKU items” refer to respective ones of the individual finished products 14 and the components parts 18.

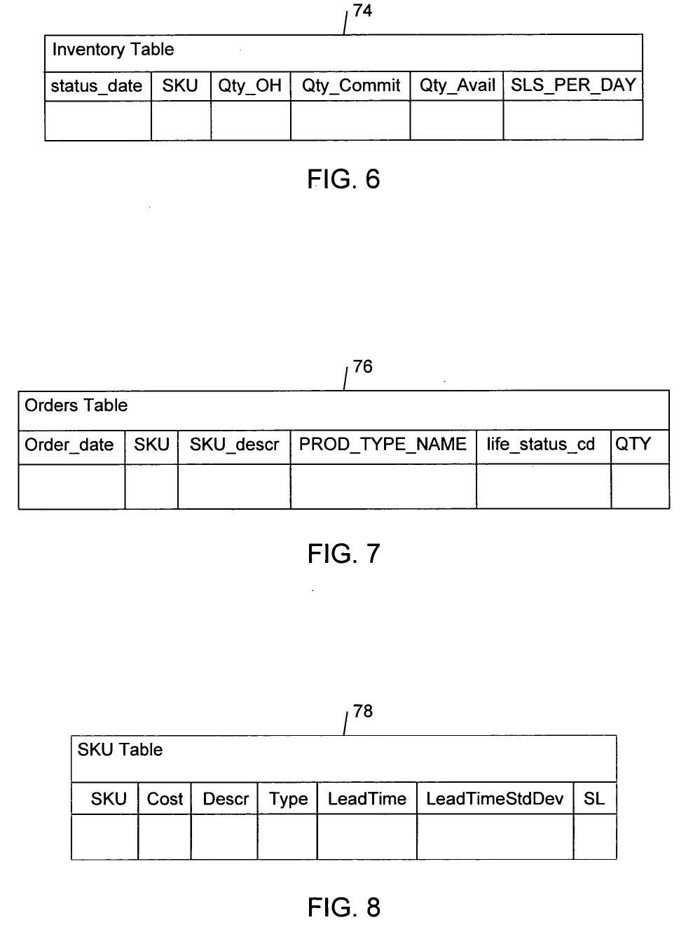

Inventory Table
FIG. 6 shows an exemplary implementation of an inventory
table 74 that contains periodic (e.g., daily) observations for
the finished products and associated parts in the baseline
product portfolio. The inventory table 74 includes the
following data fields:

| Field Name | Description |
|---|---|
| status_date | Date on which observation occurred |
| SKU | Stock Keeping Number for the finished |
| | product or component part |
| Qty_OH | Quantity on-hand at time observation was made |
| Qty_commit | Quantity committed for an order at time |
| | observation was made |
| Qty_avail | Quantity available. This value typically |
| | equals the quantity on-hand minus |
| | the quantity committed |
| SAL_PER_DAY | Number of sales that occurred |
| | on this date (demand) |

Orders Table
FIG. 7 shows an exemplary implementation of an orders table
76 that contains ordering information for the finished products
and associated parts in the baseline product portfolio at different
phases of the product life cycle. The orders table 76 includes
the following data fields:

| Field Name | Description |
|---|---|
| Order_date | Date on which the order occurred |
| SKU | Stock Keeping Number for the finished product or |
| | component part |
| SKU_descr | Text description of the SKU item |
| PROD_TYPE_Name | Name of the product type corresponding to |
| | the SKU item |
| life_status_CD | This field indicates the life cycle phase that |
| | the SKU item was in at the time that this |
| | observation was made. |
| | Exemplary life cycle phases are |
| | DISC - Discontinued. Do not sell. |
| | SUST - Mid-Life (sustained). Demand is expected |
| | to continue for the next 8 weeks. |
| | EOL - Sales are decreasing. SKU items will be |
| | discontinued within the next 8 weeks. |
| QTY | Quantity ordered |

SKU Table
FIG. 8 shows an exemplary implementation of a SKU table 78
that lists the cost, lead time, and service level for the finished
products and associated parts in the baseline product portfolio.
The SKU table 78 includes the following data fields:

| Field Name | Description |
|---|---|
| SKU | Stock Keeping Number for the finished product or |
| | component part |
| Cost | Cost of this SKU item |
| Descr | Text description of the item |
| Type | User-defined values used to classify like SKU items. |
| | Examples include processors, memory, and controllers. |
| LeadTime | Average lead time in days |
| LeadTimeStdDev | Lead time standard deviation in days |
| SL | Target service level for this SKU item, expressed as a |
| | percentage. For example, an item with an 85% |
| | service level would have a value of 0.85 in |
| | this field |

2. Computing Metrics For Evaluating The Baseline Product Portfolio

Referring back to FIG. 5, after the data for the baseline product portfolio has been received (block 72), the product portfolio analyzer 32 computes metrics for evaluating the baseline product portfolio (block 80). Among the metrics computed by the product portfolio analyzer 32 are a measure of inventory cost for the baseline product portfolio as a whole and a measure of order responsiveness for the baseline product portfolio as a whole.

In general, the inventory cost measure may be any measure that substantially reflects the cost of carrying inventory for the baseline product portfolio as a whole. In the illustrated embodiment, the inventory cost measure is the total dollar mount of inventory for all finished products in the baseline product portfolio that should be carried to meet a target service level given historical order patterns (demand variability). To compute this inventory cost measure, the product portfolio analyzer 32 computes a target inventory level (Iᵢ) for each of the finished products in the baseline product portfolio and each of the associated parts 18 in accordance with equation (1):

$${I}_{i} = \frac{{μ}_{D}}{2 \cdot df} + k \cdot \sqrt{{μ}_{D}^{2} \cdot {σ}_{L}^{2} + ( {μ}_{L} + R ) \cdot {σ}_{D}^{2} )} \qquad ( 1 )$$

The parameter k is a safety stock factor corresponding to the value of Φ⁻¹(z), where Φ⁻¹( ) is the standard normal inverse function and z is the service level specified as the probability of meeting all demand in the review period. The variable μ_{D} is the estimated mean demand, σ_{D} is the estimated standard deviation of forecast error per unit time, σ_{L} is the estimated lead time standard deviation, μ_{L} is the estimated mean lead time, R is the review period, and df is the delivery frequency. In equation (1), the factor (μ_{L}+R) corresponds to the exposure period.

The product portfolio analyzer 32 computes the total dollar amount of inventory C_{TOT}_{_{—}}_{INV} by computing the product of the target inventory level Iᵢ and the average cost Cᵢ for a respective finished product i or part i, and summing all of the product values over all finished products and associated component parts in the baseline product portfolio as follows:

$${C}_{TOT\_INV} = {\sum }_{∀ i} {I}_{i} \cdot {C}_{i} \qquad ( 2 )$$

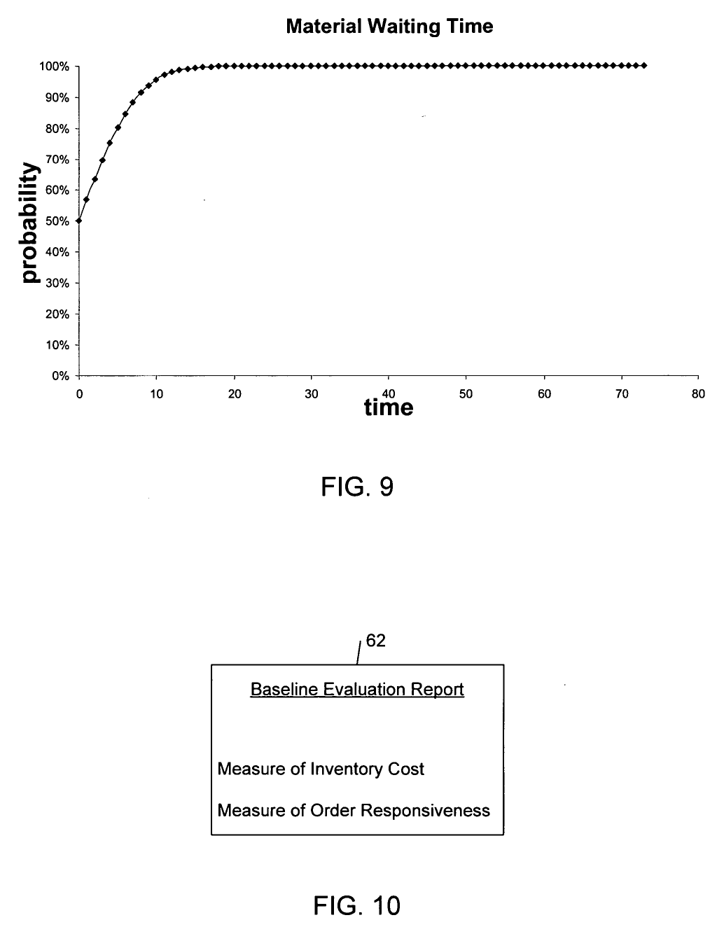

In general, the order responsiveness measure may be any measure that substantially reflects the responsiveness of the firm 16 in completing orders from customers 12 for all of the finished products 14 in the baseline product portfolio. Exemplary order responsiveness measures include order cycle time, supplier response time, and material wait time. In the illustrated embodiment, the order responsiveness measure is a material wait time (in days) that corresponds to the maximum time that a specified proportion of orders for finished products in the baseline product portfolio will take. The product portfolio analyzer 32 determines the material wait time for each of the finished products in the baseline product portfolio in accordance with equation (4):
P(MWT≦T|SL)=1−F_{μ}_{_{A}}_{,σ}_{A}(F_{μ}_{_{B}}_{,σ}_{_{B}}⁻¹(1−SL)) (4)
where
μ_{A},σ_{A}=μ_{D}·(μ_{L}+RP),\sqrt{σ_{D}²·(μ_{L}+RP)+σ_{L}²·μ_{D}²} (5)
and
μ_{B},σ_{B}=μ_{D}·(μ_{L}+RP−T),\sqrt{σ_{D}²·(μ_{L}+RP−T Λ 0)+σ_{L}²·μ_{D}²} (6)
P(MWT≦T|SL) is a measure of the probability of the material to be available in T time given that the immediate service level is SL, F(μ,σ) is a cumulative probability distribution with a mean μ and a standard deviation σ, F⁻¹(μ,σ) is an inverse cumulative probability distribution with a mean μ and a standard deviation σ, μ_{D} is a mean demand, σ_{D} is a demand variance, μ_{L} is a mean lead time, σ_{L} is a lead time variance, and RP is a review period length. The operator Λ returns the maximum of the two values on either side of the operator. FIG. 9 shows an exemplary plot of P(MWT≦T|SL) for a given service level (SL). This plot typically is referred to as an “order aging curve”. The order aging curve maps specified proportions of orders that can be completed to corresponding material wait time values. Thus, for a given probability value, the material wait time can be determined.

The product portfolio analyzer 32 computes the material wait time for the baseline product portfolio as a whole by setting the function P(MWT≦T|SL) in equation (4) to a prescribed probability level (e.g., 90%) and solving for MWT. By determining the MWT values for each of the finished products in the baseline product portfolio, the product portfolio analyzer 32 may determine the material wait time for the baseline product portfolio as a whole.

3. Presenting The Computed Evaluation Metrics

As shown in FIG. 10, in some embodiments, the computed measure of inventory cost and the computed measure of order responsiveness are presented in the baseline evaluation report 62. The baseline evaluation report 62 allows the user 40 to compare actual inventory cost and actual material wait time in the baseline product portfolio with the target levels for these measures computed by the product portfolio analyzer 32.

In some implementations, the inventory cost and order responsiveness measures are computed under the assumption that inventories of all parts are held at the same service levels. In this way, the baseline evaluation report 62 may be used to determine how much better the baseline product portfolio would have performed in terms of inventory cost and material wait time if the specified target service level had been achieved across all finished products and component parts. In other implementations, the user 40 may specified a respective target service level for each of the finished products and component parts in the baseline product portfolio.

In addition to the baseline evaluation report 62, the product portfolio analyzer 32 presents one or more performance reports that contain sets of relevant metrics that enable the user 40 to identify candidate finished products and parts for removal from the baseline product portfolio.

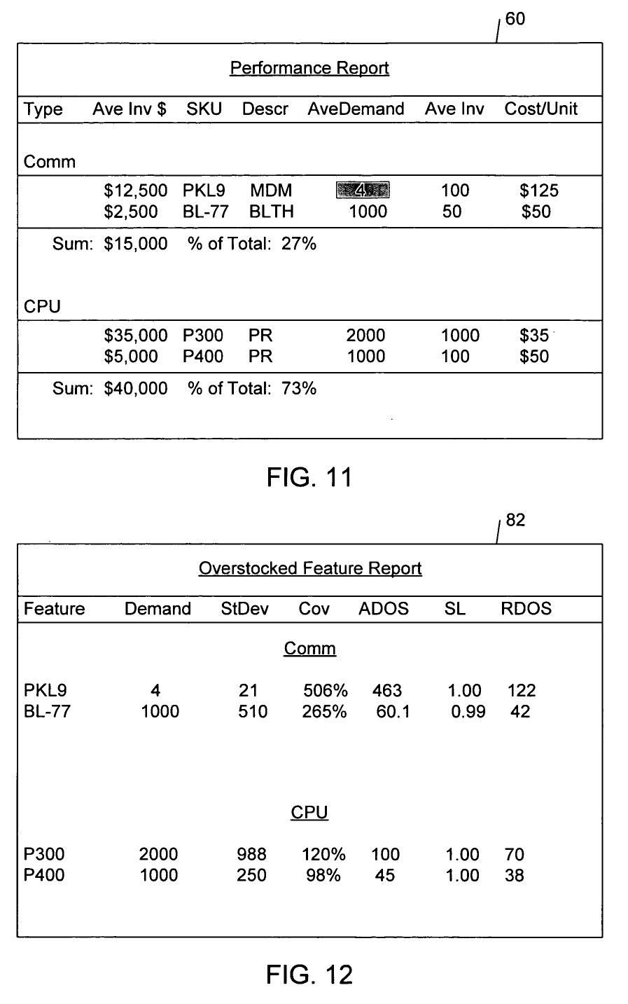

FIG. 11 shows an implementation of the performance report 60 that performance report contains, among other parameter values, average inventory cost (Ave Inv $) and average demand (AveDemand) for each of one or more finished products and associated parts in the baseline product portfolio. In the illustrated implementation, the performance report 60 includes the following data fields:

| Field Name | Description |
|---|---|
| Type | This corresponds to the “Type” field in the SKU table 78 |
| Ave Inv $ | The average dollar amount of inventory for the item. |
| SKU | Stock Keeping Number for the finished product or |
| | component part |
| Descr | Text description of the item |
| Min I Date | First date for which there is inventory observation for this |
| | item. |
| Max I Date | Last date for which there is inventory observation for this |
| | item. |
| Min O Date | First date for which there is order data for this item |
| Max O Date | Last date for which there is order data for this item |
| AveDemand | Average demand in units per day |
| Ave Tiv | Average inventory in days of supply |
| Cost/Unit | Dollar cost per unit for this item |

The “Min” and “Max” data columns are useful for assessing the completeness of the product data.

The data that is presented in the performance report 60 may be sorted by the values in any of the columns. In one implementation, the data are sorted by default in accordance with the values in the Ave Inv $ field. This sorting of the data allows the user 40 to readily identify those SKU items that have high average inventory costs. Eliminating these SKU items from the baseline product portfolio potentially might have the greatest impact on reducing the inventory cost for the baseline product portfolio as a whole.

The user 40 may identify those high-inventory-cost items that are associated with relatively low average demand as low-performing SKU items. In some implementations, the user may set a threshold average demand level and those SKU items having an average demand level below the threshold level are highlighted in the performance report 60. For example, the low-performing SKU item PLK9 is highlighted in the exemplary performance report 60 shown in FIG. 11. Items near the top of each product type section of the performance report 60 that also are associated with relatively low average demand typically are good candidates for removal from the baseline product portfolio. As explained in the following section, the user 40 may shift some or all of the demand for such high-cost, low-performing SKU items to one or more high-performing SKU items in a product portfolio scenario.

FIG. 12 shows an implementation of an overstocked feature performance report 82 that contains the following data fields:

| Field | |
|---|---|
| Name | Description |
| Type | This corresponds to the “Type” field in the SKU table 78 |
| Feature | The name of the reported SKU item |
| Demand | The average daily demand for each SKU item in the |
| | reporting timeframe as entered previously in the start and |
| | end date windows |
| StdDev | The standard deviation of the daily demand for each SKU |
| | item |
| Cov | The covariance of the daily demand for each SKU item |
| ADOS | The actual days of supply for each SKU item |
| SL | The implied service level for each SKU item. A value of 1.00 |
| | shows that the inventory level is so high that it is unfeasible |
| | to calculate the implied service level. |
| RDOS | Recommended days of supply. Calculated based on a |
| | service level of 99.9% and the actual demand uncertainty |
| | for the SKU item. |

The calculation engine automatically computes the implied service level by solving for the safety stock factor k in equation (1) and then solving for the service level z=Φ(k), where Φ( ) is the standard normal cumulative distribution function.

The overstocked feature performance report 82 assists the user 40 in identifying SKU items that have excessive stocking levels and therefore might be candidates for elimination from the baseline product portfolio. In particular, SKU items that are associated with an unfeasibly high implied service level typically are associated with excessive stocking levels. The user 40 can readily identify such SKU items in the overstocked feature performance report 82 by identifying SKU items with high implied services levels (e.g., implied service levels equal to 1.00).

In some implementations, the product portfolio analyzer 32 is configured to present additional reports that assist the user 40 in identifying SKU items for possible elimination from the baseline product portfolio. For example, in some implementations, the product portfolio analyzer 32 presents a demand plot showing demand over a planning horizon and an inventory plot showing inventory levels over the planning horizon. The demand plot allows the user 40 to identify SKU items having high demand variability and therefore might be considered as possible candidates for elimination from the baseline product portfolio. The inventory plot allows the user 40 to identify SKU items that are associated with sustained periods of inventory build-up or stock-outs and therefore might be considered as possible candidates for elimination from the baseline product portfolio.

C. Comparing the Baseline Product Portfolio to One or More Product Portfolio Scenarios

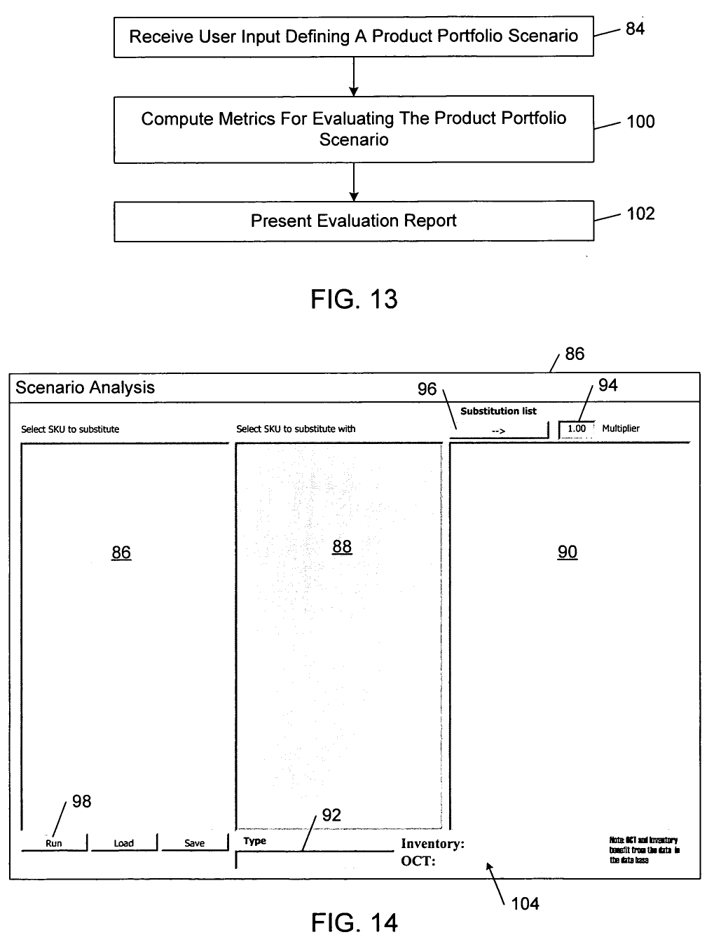

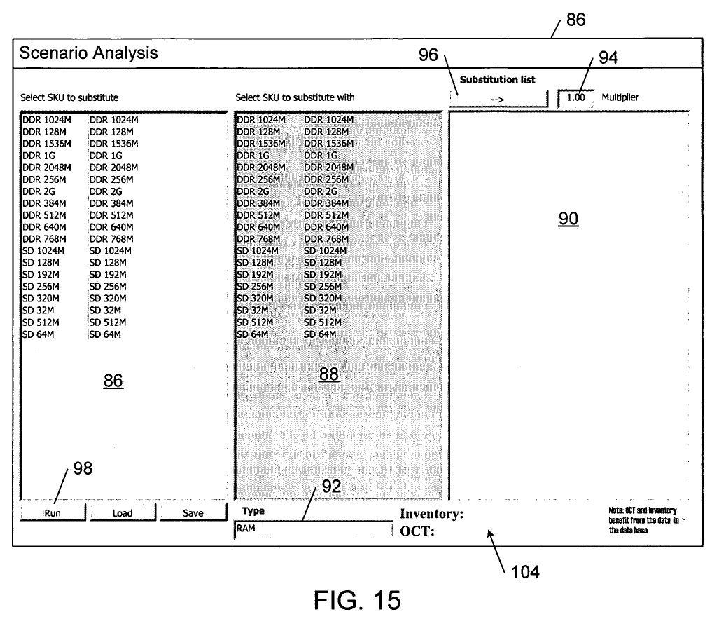

FIG. 13 shows an embodiment of a method by which the product portfolio analyzer 32 analyzes product portfolio scenarios. This method allows the user 40 specifies different product portfolio scenarios and to compare the baseline product portfolio to these different in terms of one or more evaluation metrics. In the illustrated embodiment, the product portfolio analyzer 32 compares different product portfolios in terms of inventory cost and order responsiveness.

In accordance with this method, the product portfolio analyzer 32 initially receives user input defining a product portfolio scenario (block 84). To this end, the graphical user interface 36 presents a Scenario Analysis interface window 86, which is shown in FIG. 14. The Scenario Analysis window 86 includes a “Select SKU to substitute” column 88 for displaying a list of the SKU items in the baseline product portfolio, a “Select SKU to substitute with” column for displaying a list of SKU items that might be substitute for SKU items eliminated from the baseline product portfolio, and a “Substitution list” column 90 for displaying a list of the

SKU item substitutions that correspond to the transformation of the baseline product portfolio to the product portfolio scenario. In the illustrated embodiment, the product portfolio analyzer 32 organizes the SKU items in the baseline product portfolio by SKU item Type, which the user specifies using a Type input box 92.

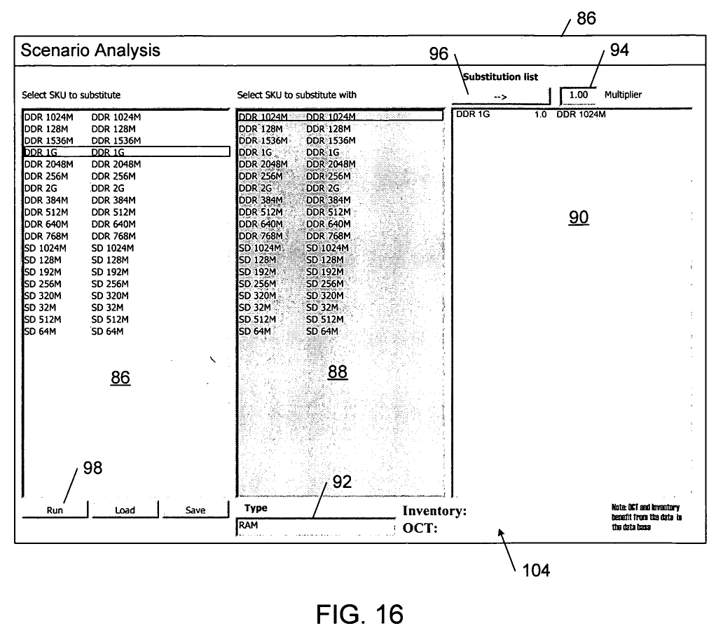

In operation, the user 40 selects a SKU item Type (e.g., RAM) from a drop down menu that is associated with the Type input box 92 and lists all of the SKU item Types for the items in the baseline product portfolio. In response, the graphical user interface 36 populates both the “Select SKU to substitute” column 86 and the “Select SKU to substitute with” column 88 with all of the SKU items in the baseline product portfolio for which demand data is available. The user 40 then selects at least one SKU item in the “Select SKU to substitute” column 86 and a SKU item in the “Select SKU to substitute with” column 88. The SKU items selected in the “Select SKU to substitute” column 86 will be excluded from the product portfolio scenario, and the SKU items selected in the “Select SKU to substitute with” column 88 are the items that will replace, in whole or in part, the items being eliminated from the baseline product portfolio for the purposes of demand substitution. For example, in the example shown in FIG. 16, the Scenario Analysis window 86 highlights the SKU DDR 1G in the “Select SKU to substitute” column 86 and highlights the SKU DDR 1024M in the “Select SKU to substitute with” column 88 to reflect the user's indication to substitute SKU DDR 1G with SKU DDR 1024M in the product portfolio scenario.

The user 40 also enters a demand multiplier value between 0 and 1 in a Multiplier input box 94. The demand multiplier value specifies the proportion of demand to shift from the item eliminated in column 86 to the selected target items in column 88. For example, a multiplier value of 1.00 corresponds to movement of 100% of the demand, whereas a multiplier value of 0.8 corresponds to movement of 80% of the demand. A demand multiplier value of 0 indicates that the SKU item that is selected in the “Select SKU to substitute” column 86 is to be eliminated from the product portfolio scenario with no demand substitution. The Scenario Analysis window 86 also allows the user 40 to split demand for eliminated items among multiple replacement items.

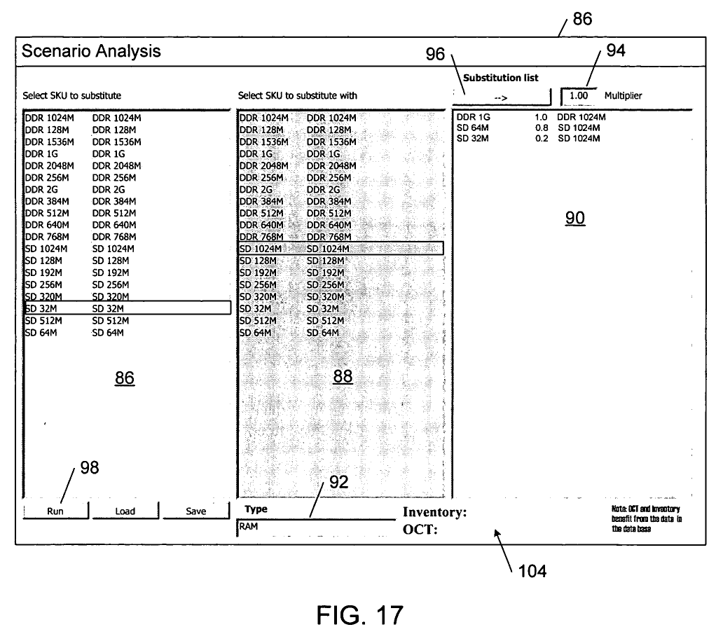

After each demand substitution has been specified by the user 40, the user selects the arrow button 96, which causes the demand substitution to be listed in the “Substitution list” column 90, as shown in FIG. 16. Referring to FIG. 17, after the user 40 has finished specifying a set of SKU items to be eliminated from the baseline product portfolio and the SKU items that will replace the eliminated items in the product portfolio scenario, the user 40 selects the Run button 98.

Referring back to FIG. 13, the calculation engine 38 computes metrics for evaluating the product portfolio scenario in response to the user's selection of the Run button 98 (block 100). Among the metrics computed by the calculation engine 38 in the illustrated embodiments are a measure of inventory cost for the product portfolio scenario as a whole and a measure of order responsiveness for the product portfolio scenario as a whole. In this process, the calculation engine 38 derives the new demand pattern 68 (shown in FIG. 4) for the product portfolio scenario based on the demand data 54 and the demand substitution inputs received from the user 40. In particular, the demand data 54 for the substituted items is scaled by the demand multipliers specified by the user 40 to obtain the demand for the specified replacement items in the product portfolio scenario. The resulting demand pattern then may be used to compute the measures of inventory cost and order responsiveness for the product demand scenario in the same manner explained above in connection with the baseline product portfolio.

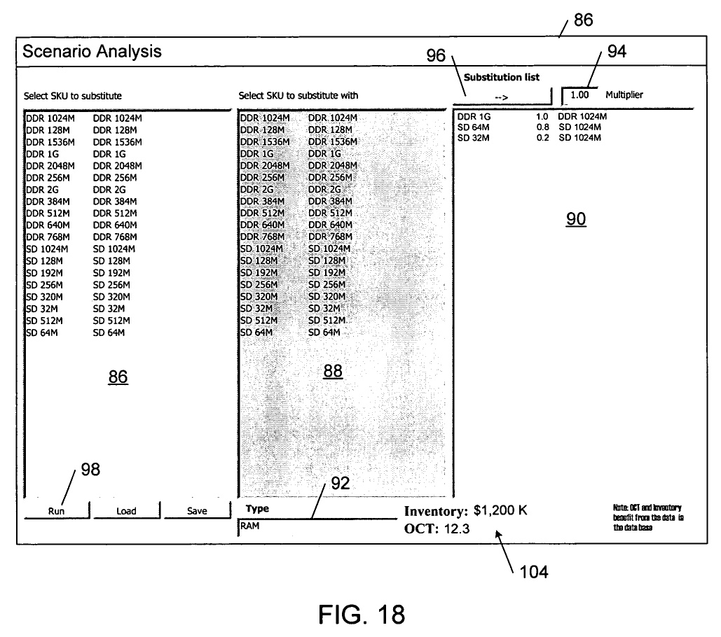

The graphical user interface 36 then presents a scenario evaluation report 70 comparing the baseline product portfolio and the product portfolio scenario (block 102). In the illustrated embodiments, the graphical user interface 36 presents the scenario evaluation report 70 in a results window 104, as shown in FIG. 18. The Inventory area of the results window 104 shows the expected dollar improvement in the amount of inventory that would need to be held to meet the target service levels given historical demand uncertainty by changing from the baseline product portfolio to the product portfolio scenario. Positive inventory numbers indicate the amount of expected inventory cost savings, whereas negative inventory numbers indicate the amount by which inventory costs are expected to increase. The OCT (Order Cycle Time) area of the results window 104 shows the expected improvement in order cycle time in days by changing from the baseline product portfolio to the product portfolio scenario. Once again, positive numbers indicate the amount of expected order cycle time improvement, whereas negative numbers indicate the amount by which the order cycle time is expected to increase.

The baseline and scenario evaluation reports 62, 70 allow the user to examine the benefits that are expected to be realized if some products in the baseline product portfolio are eliminated in favor of others. In one example, suppose the user 40 ran generated a baseline product portfolio for an 85% target service level and the baseline evaluation report indicated that the inventory cost should be $100,000 with a material wait time of 30.5 days at 90% availability. In addition, assume that the user 40 specified a product portfolio scenario characterized by an expected inventory cost saving of $10,000 and an order cycle time improvement of 10 days. In some implementations, the inventory cost improvement and order cycle time improvement values in the scenario evaluation report 70 are based on the higher of the actual historical inventory levels and the invention levels needed to achieve an 85% service level. In effect, this output is the combination of setting identical service levels across all SKU items as in the baseline evaluation report 62 and reducing the range of product offerings simultaneously. Therefore, if too much inventory is being carried in the baseline product portfolio, the scenario evaluation report will reveal the benefits indexed to historical levels for parts identified for substitution.

The user 40 may specify multiple product portfolio scenarios and compare each product portfolio scenario to the baseline product portfolio until a product portfolio scenario representing the greatest improvement in inventory cost savings and/or order cycle time improvement has been identified.

IV. Conclusion

Other embodiments are within the scope of the claims. For example, the systems and methods described herein are not limited to any particular hardware or software configuration, but rather they may be implemented in any computing or processing environment, including in digital electronic circuitry or in computer hardware, firmware, or software.

What is claimed is:

1. A machine-implemented method of analyzing product portfolios, comprising:
receiving demand data, lead time data, and inventory data for a product portfolio comprising a set of finished products manufactured from a set of associated parts;
computing a measure of inventory cost for the product portfolio as a whole;
computing a measure of order responsiveness for the product offering as a whole; and
presenting a report evaluating the product portfolio based on the computed measures of inventory cost and order responsiveness.

2. The method of claim 1, wherein the computing of the inventory cost measure comprises computing a cost of inventory levels of the finished products and associated parts needed to cover uncertainty in demand over an exposure period with a target service level.

3. The method of claim 1, wherein the computing of the order responsiveness measure comprises determining a material wait time corresponding to an expected amount of time needed to complete a specified proportion of orders for a given finished product in the product portfolio with a target service level.

4. The method of claim 1, further comprising presenting a portfolio performance report containing average inventory cost and average demand for each of one or more finished products and associated parts in the product portfolio.

5. The method of claim 4, wherein finished products and associated parts are listed in the performance report in order of highest average inventory cost.

6. The method of claim 1, further comprising computing implied service levels for respective ones of the finished products and associated parts in the product portfolio.

7. The method of claim 1, further comprising presenting an overstocked feature report containing demand, implied service level, actual days of supply, and recommended days of supply for each of one or more finished products and associated parts in the product portfolio.

8. The method of claim 1, further comprising receiving user input defining a second product portfolio comprising a second set of finished products manufactured from a second set of associated parts.

9. The method of claim 8, further comprising computing a measure of inventory cost and a measure of order responsiveness for the second product portfolio as a whole.

10. The method of claim 9, wherein the portfolio evaluation report presents a comparison of the inventory cost measures and the order responsiveness measures computed for the first and second product portfolios.

11. The method of claim 10, wherein the comparison comprises an expected difference in inventory cost and an expected difference in order cycle time between the first and second product portfolios.

12. The method of claim 8, wherein the receiving of the user input comprises presenting a list of the finished products and associated parts in the first product portfolio, and providing an interface enabling a user to specify modifications to the present list to arrive at the finished products and associated parts in the second product portfolio.

13. The method of claim 12, wherein the interface enables the user to replace designated ones of the finished products and associated parts in the first product portfolio with designated ones of the finished products and associated parts in the second product portfolio.

14. The method of claim 13, wherein the interface enables the user to specify a proportion of demand to shift from replaced ones of the finished products and associated parts in the first product portfolio to designated ones of the finished products and associated parts in the second product portfolio.

15. The method of claim 14, wherein the computing of the inventory cost measure comprises computing demand data for the second product portfolio based on the received demand data and the user-specified proportions of shifted demand.

16. A machine for analyzing product portfolios at least one data processing module configured to:
receive demand data, lead time data, and inventory data for a product portfolio comprising a set of finished products manufactured from a set of associated parts;
compute a measure of inventory cost for the product portfolio as a whole;
compute a measure of order responsiveness for the product offering as a whole; and
present a report evaluating the product portfolio based on the computed measures of inventory cost and order responsiveness.

17. The machine of claim 16, wherein the at least one data processing module is configured to compute a cost of inventory levels of the finished products and associated parts needed to cover uncertainty in demand over an exposure period with a target service level.

18. The machine of claim 16, wherein the at least one data processing module is configured to determine a material wait time corresponding to an expected amount of time needed to complete a specified proportion of orders for a given finished product in the product portfolio with a target service level.

19. The machine of claim 16, wherein the at least one data processing module is configured to present a portfolio performance report containing average inventory cost and average demand for each of one or more finished products and associated parts in the product portfolio.

20. The machine of claim 19, wherein the at least one data processing module is configured to list the finished products and associated parts in the performance report in order of highest average inventory cost.

21. The machine of claim 16, wherein the at least one data processing module is configured to compute implied service levels for respective ones of the finished products and associated parts in the product portfolio.

22. The machine of claim 16, wherein the at least one data processing module is configured to present an overstocked feature report containing demand, implied service level, actual days of supply, and recommended days of supply for each of one or more finished products and associated parts in the product portfolio.

23. The machine of claim 16, wherein the at least one data processing module is configured to receive user input defining a second product portfolio comprising a second set of finished products manufactured from a second set of associated parts.

24. The machine of claim 23, wherein the at least one data processing module is configured to compute a measure of inventory cost and a measure of order responsiveness for the second product portfolio as a whole.

25. The machine of claim 24, wherein the portfolio evaluation report presents a comparison of the inventory cost measures and the order responsiveness measures computed for the first and second product portfolios.

26. The machine of claim 25, wherein the comparison comprises an expected difference in inventory cost and an expected difference in order cycle time between the first and second product portfolios.

27. The machine of claim 23, wherein the at least one data processing module is configured to present a list of the finished products and associated parts in the first product portfolio and provide an interface enabling a user to specify modifications to the present list to arrive at the finished products and associated parts in the second product portfolio.

28. The machine of claim 27, wherein the interface enables the user to replace designated ones of the finished products and associated parts in the first product portfolio with designated ones of the finished products and associated parts in the second product portfolio.

29. The machine of claim 28, wherein the interface enables the user to specify a proportion of demand to shift from replaced ones of the finished products and associated parts in the first product portfolio to designated ones of the finished products and associated parts in the second product portfolio.

30. The machine of claim 29, wherein the at least one data processing module is configured to compute demand data for the second product portfolio based on the received demand data and the user-specified proportions of shifted demand.

31. A computer program for analyzing product portfolios, the computer program residing on a computer-readable medium and comprising computer-readable instructions for causing a computer to:
receive demand data, lead time data, and inventory data for a product portfolio comprising a set of finished products manufactured from a set of associated parts;
compute a measure of inventory cost for the product portfolio as a whole;
compute a measure of order responsiveness for the product offering as a whole; and
present a report evaluating the product portfolio based on the computed measures of inventory cost and order responsiveness.

32. The computer program of claim 31, wherein the computer-readable instructions cause the computer to compute a cost of inventory levels of the finished products and associated parts needed to cover uncertainty in demand over an exposure period with a target service level.

33. The computer program of claim 31, wherein the computer-readable instructions cause the computer to determine a material wait time corresponding to an expected amount of time needed to complete a specified proportion of orders for a given finished product in the product portfolio with a target service level.

34. The computer program of claim 31, wherein the computer-readable instructions cause the computer to present a portfolio performance report containing average inventory cost and average demand for each of one or more finished products and associated parts in the product portfolio.

35. The computer program of claim 34, wherein the computer-readable instructions cause the computer to list the finished products and associated parts in the performance report in order of highest average inventory cost.

36. The computer program of claim 31, wherein the computer-readable instructions cause the computer to compute implied service levels for respective ones of the finished products and associated parts in the product portfolio.

37. The computer program of claim 31, wherein the computer-readable instructions cause the computer to present an overstocked feature report containing demand, implied service level, actual days of supply, and recommended days of supply for each of one or more finished products and associated parts in the product portfolio.

38. The computer program of claim 31, wherein the computer-readable instructions cause the computer to receive user input defining a second product portfolio comprising a second set of finished products manufactured from a second set of associated parts.

39. The computer program of claim 38, wherein the computer-readable instructions cause the computer to compute a measure of inventory cost and a measure of order responsiveness for the second product portfolio as a whole.

40. The computer program of claim 39, wherein the portfolio evaluation report presents a comparison of the inventory cost measures and the order responsiveness measures computed for the first and second product portfolios.

41. The computer program of claim 40, wherein the comparison comprises an expected difference in inventory cost and an expected difference in order cycle time between the first and second product portfolios.

42. The computer program of claim 38, wherein the computer-readable instructions cause the computer to present a list of the finished products and associated parts in the first product portfolio and provide an interface enabling a user to specify modifications to the present list to arrive at the finished products and associated parts in the second product portfolio.

43. The computer program of claim 42, wherein the interface enables the user to replace designated ones of the finished products and associated parts in the first product portfolio with designated ones of the finished products and associated parts in the second product portfolio.

44. The computer program of claim 43, wherein the interface enables the user to specify a proportion of demand to shift from replaced ones of the finished products and associated parts in the first product portfolio to designated ones of the finished products and associated parts in the second product portfolio.

45. The computer program of claim 44, wherein the computer-readable instructions cause the computer to compute demand data for the second product portfolio based on the received demand data and the user-specified proportions of shifted demand.
